(19) United States
(12) Patent Application Publication
(10) Pub. No.: US 2017/0078457 A1
(43) Pub. Date: Mar. 16, 2017

(54) COMMUNICATION DEVICE, RELAY DETERMINATION METHOD, AND COMPUTER PROGRAM PRODUCT

(71) Applicant: KABUSHIKI KAISHA TOSHIBA, Tokyo (JP)

(72) Inventors: Hiroki KUDO, Kawasaki (JP); Fumiaki KANAYAMA, Kawasaki (JP); Ren SAKATA, Yokohama (JP); Yusuke DOI, Kawasaki (JP)

(21) Appl. No.: 15/258,537

(22) Filed: Sep. 7, 2016

(30) Foreign Application Priority Data
Sep. 11, 2015 (JP) 2015-180192

(51) Int. Cl. H04L 29/06; H04L 12/741; H04B 17/318; H04B 7/155

(52) U.S. Cl. CPC H04L 69/22; H04B 7/155; H04L 45/74; H04B 17/318

(57) ABSTRACT

According to an embodiment, a communication device includes a determiner, an extractor, and an identifier. The determiner is configured to determine whether received data is addressed to the communication device. The extractor configured to extract data satisfying a determination criterion for setting data as relay data, from received data determined not to be addressed to the communication device. The identifier is configured to identify, as relay data, received data determined to be addressed to the communication device and the extracted data.

### CROSS-REFERENCE TO RELATED APPLICATION

This application is based upon and claims the benefit of priority from Japanese Patent Application No. 2015-180192, filed on Sep. 11, 2015; the entire contents of which are incorporated herein by reference.

### FIELD

Embodiments described herein relate generally to a communication device, a relay determination method, and a computer program product.

### BACKGROUND

In a wireless mesh network, the conventional technique relays data through a plurality of paths between communication devices so as to prevent failure of data delivery to an aggregation device that aggregates data because of unsuccessful data reception due to, for example, interference between communication devices that relay data. For example, a technique called flooding relays data between all communication devices that receive transmitted data. In the flooding, data is relayed through a plurality of redundant paths, and thus a data delivery rate to the aggregation device can be improved. In another technique, for example, when there is a communication device that could not receive data, neighboring communication devices detect this unsuccessful reception, and then the data is retransmitted. With this configuration, communication devices that have detected the unsuccessful data reception retransmit the data to the destination at once, which leads to an improved data delivery rate to the aggregation device. Examples of known conventional techniques are described in Japanese Patent Application Laid-open No. 2008-236229.

In the above-described conventional techniques, data is relayed through a plurality of redundant paths so as to achieve highly reliable communication, which potentially results in increase in a network load and lack of wireless bandwidth. In addition, Recent needs request low electric power consumption of the wireless mesh network. For example, in a wireless mesh network that achieves low electric power consumption, communication opportunities and transmission of reception confirming responses such as ACK and NACK between communication devices are restricted in some cases. In such a case, the above-described conventional techniques are unable to relay data through a plurality of redundant paths due to the restriction of communication opportunities and reception confirming responses, which makes it difficult to achieve low electric power consumption and highly reliable communication in the wireless mesh network.

### BRIEF DESCRIPTION OF THE DRAWINGS

FIG. 1 is a diagram illustrating a system configuration of a relay determination system according to a first embodiment;

FIG. 2 is a diagram illustrating a hardware configuration of a communication device according to the first embodiment;

FIG. 3 is a block diagram illustrating a functional configuration of the communication device according to the first embodiment;

FIG. 4 is a diagram illustrating a wireless communication method executed by the communication device according to the first embodiment;

FIG. 5 is a diagram illustrating a communication frame used by a relay determination system according to the first embodiment;

FIG. 6 is a diagram illustrating processing using a determination criterion according to the first embodiment;

FIG. 7 is a flowchart of the process of processing at a reception stand-by for a child group according to the first embodiment;

FIG. 8 is a flowchart of the process of processing at transmission for an own group according to the first embodiment;

FIG. 9 is a flowchart of the process of processing at transmission for an own group according to the first embodiment;

FIG. 10 is a block diagram illustrating a functional configuration of a communication device according to a second embodiment;

FIG. 11 is a diagram illustrating processing using a determination criterion according to the second embodiment;

FIG. 12 is a flowchart of the process of processing at transmission for an own group according to the second embodiment;

FIG. 13 is a block diagram illustrating a functional configuration of a communication device according to a third embodiment;

FIG. 14 is a diagram illustrating a communication frame used by a relay determination system according to the third embodiment;

FIG. 15 is a flowchart of update processing of a relay flag according to the third embodiment;

FIG. 16A is a diagram illustrating a wireless communication method executed by a communication device according to the third embodiment;

FIG. 16B is a diagram illustrating a wireless communication method executed by a communication device according to the third embodiment; and

FIG. 17 is a flowchart of update processing of a relay flag according to the third embodiment.

### DETAILED DESCRIPTION

According to an embodiment, a communication device includes a determiner, an extractor, and an identifier. The determiner is configured to determine whether received data is addressed to the communication device. The extractor configured to extract data satisfying a determination criterion for setting data as relay data, from received data determined not to be addressed to the communication device. The identifier is configured to identify, as relay data, received data determined to be addressed to the communication device and the extracted data.

### First Embodiment

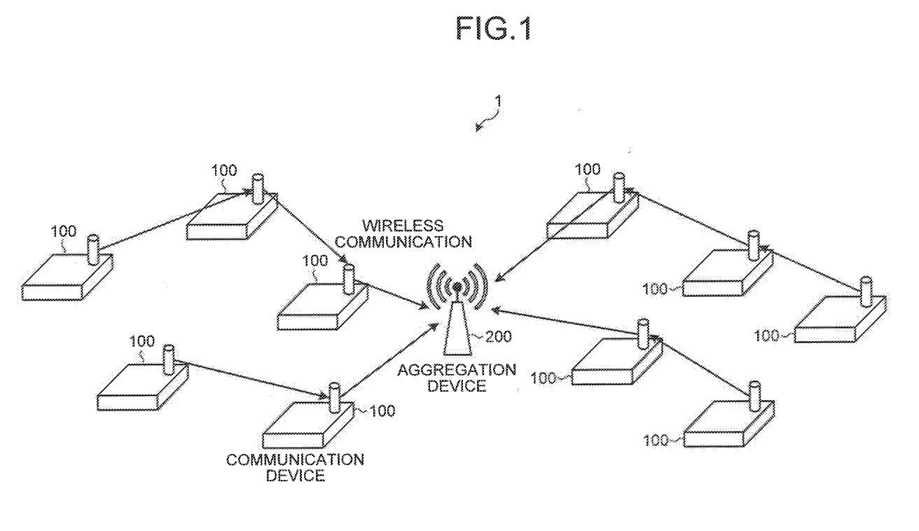

FIG. 1 is a diagram illustrating an exemplary system configuration of a relay determination system 1 according to a first embodiment. As illustrated in FIG. 1, the relay determination system 1 includes a plurality of communication devices 100 configured to perform multihop relay transmission of data through wireless communication, and an aggregation device 200 configured to aggregate data from the communication devices 100. The present embodiment is applicable to a multihop network or a mesh network that does not explicitly include the aggregation device 200 but includes the communication devices 100.

In the configuration described above, each communication device 100 sets received data as relay candidate data and determines whether the relay candidate data is addressed to the own node. Specifically, the communication device 100 sets, as relay candidate data, all received data including data addressed to the own node and data not addressed to the own node, and determines whether the relay candidate data is addressed to the own node.

The communication device 100 classifies the relay candidate data determined to be addressed to the own node as first data, and classifies relay candidate data determined not to be addressed to the own node as second data. Specifically, the communication device 100 classifies the relay candidate data determined to be addressed to the own node as the first data that is one piece of the relay data. In other words, data addressed to the own node is data to be relayed and thus is classified as the first data that is one piece of the relay data. The communication device 100 classifies relay candidate data determined not to be addressed to the own node as the second data that is a target of determination processing to be described later.

Then, the communication device 100 extracts, from the second data, third data that satisfies a determination criterion for setting data as relay data. Specifically, the communication device 100 extracts data that satisfy the applying determination criterion as relay data, as the third data that is one piece of the relay data, from among the second data remaining as relay candidate data. The determination criterion will be described later in detail. Thereafter, the communication device 100 identifies the first data and the third data as relay data. Specifically, the communication device 100 identifies, as relay data, the first data that is data addressed to the own node and the third data that is relay candidate data that satisfy the applying determination criterion as relay data.

Thus, the communication device 100 identifies, as relay data, data addressed to the own node and relay candidate data that satisfies the applying determination criterion as relay data among relay candidate data not addressed to the own node. In other words, the communication device 100 relays, as relay data, data that satisfy the applying determination criterion as relay data, instead of relaying all received data as relay data. As a result, the communication device 100 can suppress increase in a network load and lack of wireless bandwidth to achieve highly reliable communication.

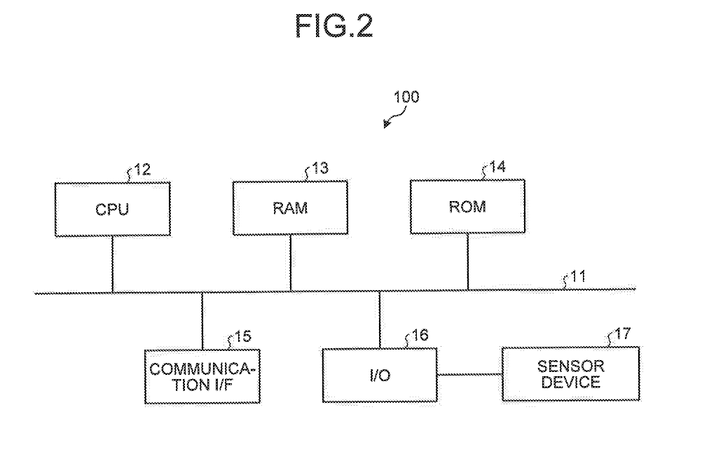

FIG. 2 is a diagram illustrating an exemplary hardware configuration of the communication device 100 according to the first embodiment. As illustrated in FIG. 2, the communication device 100 includes a central processing unit (CPU) 12, a random access memory (RAM) 13, a read only memory (ROM) 14, a communication I/F 15, an I/O 16, and a sensor device 17. These pieces of hardware are connected with each other through a system bus 11.

The CPU 12 controls the entire operation of the communication device 100. The CPU 12 executes a computer program stored in, for example, the ROM 14 by using a work area such as the RAM 13 so as to control the entire operation of the communication device 100. The control includes data communication, determination of relay data for relay transmission, measurement by a sensor, and sleep control. The RAM 13 temporarily stores therein, for example, measured data and information on various kinds of processing, and serves as a work area used for executing a computer program stored in, for example, the ROM 14. The ROM 14 stores therein a computer program for achieving processing by the communication device 100. The communication I/F 15 is an interface for controlling wireless communication. For example, the communication I/F 15 is an interface compliant with various wireless standards applicable to a wireless local area network (LAN) by IEEE 802.11a/b/g/n/ac, Bluetooth (registered trademark), Zigbee (registered trademark), a LAN by, for example, 920 MHz wireless communication, and a personal area network (PAN). The I/O 16 controls inputting and outputting of various kinds of information such as measured data and a control signal to the sensor device 17. The sensor device 17 may be any of various sensors for sensing light, heat, sound, and the like, and outputs measured data. Measured data is adopted as one piece of the relay data.

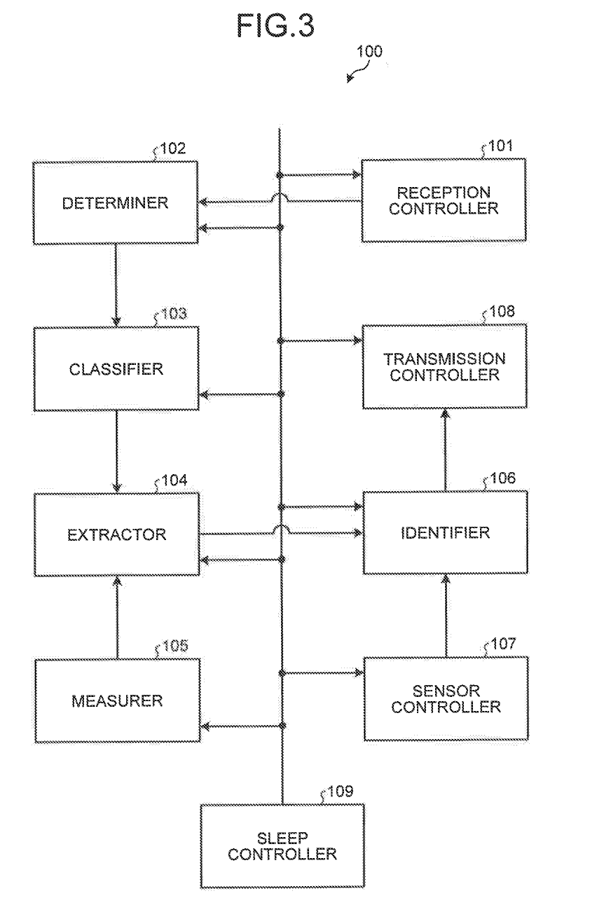

FIG. 3 is a block diagram of an exemplary functional configuration of the communication device 100 according to the first embodiment. As illustrated in FIG. 3, the communication device 100 includes a reception controller 101, a determiner 102, a classifier 103, an extractor 104, a measurer 105, an identifier 106, a sensor controller 107, a transmission controller 108, and a sleep controller 109. Part or all of these units may be achieved by software (computer program) or by hardware.

The reception controller 101 controls reception processing of received data as a radio signal by the communication I/F 15. The determiner 102 sets the received data as relay candidate data and determines whether relay candidate data is addressed to the own node. More specifically, the determiner 102 sets the received data received from the reception controller 101 as relay candidate data, and adds information on the relay candidate data to a relay candidate list. Then, the determiner 102 determines whether each relay candidate data is addressed to the own node based on the relay candidate list. For example, whether the data is addressed to the own node is determined based on a unique destination identifier included in the received data. The unique destination identifier is the address of a node set as a destination by the communication device 100 that is a transmission source. In other words, if the unique destination identifier included in the received data matches the own address, it is determined that the received data is data addressed to the own node.

The classifier 103 classifies relay candidate data determined to be addressed to the own node as the first data, and classifies relay candidate data determined not to be addressed to the own node as the second data. More specifically, the classifier 103 classifies the relay candidate data determined to be addressed to the own node as the first data that is one piece of the relay data, based on a result of the determination by the determiner 102. The classifier 103 classifies, based on a result of the determination by the determiner 102, the relay candidate data determined not to be addressed to the own node as the second data that is a target of the determination processing of whether to apply the data as relay data. The classifier 103 deletes the relay candidate data classified as the first data that is one piece of the relay data, from the relay candidate list.

The extractor 104 extracts the third data satisfying the determination criterion for setting data as relay data from the second data. More specifically, the extractor 104 extracts the third data satisfying the determination criterion from among the second data, as a target of the determination processing using the determination criterion for applying, as relay data, the second data classified by the classifier 103. The third data is adopted as one piece of the relay data. The extractor 104 deletes the relay candidate data extracted as the third data that is one piece of the relay data, from the relay candidate list. In the first embodiment, among relay candidate data included in the relay candidate list, relay candidate data received from a transmission source node having a lower quality of communication with the own node is extracted as the third data. The quality of communication is measured by the measurer 105.

The measurer 105 measures a parameter indicating the quality of communication between the own node and the transmission source node. For example, the quality of communication can be measured as a received radio wave strength of a radio signal, an indicator of a received radio wave strength, such as a received signal strength indicator (RSSI), a packet error rate, and a signal to noise ratio (SNR). The measurer 105 adds the measured quality of communication to the relay candidate list. Then, the extractor 104 sorts the relay candidate list in an ascending order of the quality of communication based on the quality of communication measured by the measurer 105, and extracts T (T≧0) pieces of data having lowest values of the quality of communication as the third data. “T” is set to an optional number in accordance with, for example, the number of communication devices 100 included in the relay determination system 1 and a network configuration. Setting relay candidate data having a lower quality of communication in the relay candidate list as relay data is equivalent to applying received data from a transmission source node further spatially distant from the own node as relay data.

When a determination criterion related to the quality of communication is used, the third data cannot be desirably extracted due to, for example, instantaneous degradation, such as fading, of the quality of wireless communication in some cases. For this reason, the quality of communication may be determined based not only on the quality of communication at data reception but also on the quality of communication in the past. For example, the communication device 100 may add the quality of communication to the relay candidate list, and without deleting the relay candidate list, may calculate an average value of the quality of communication additionally including a parameter of the quality of communication in the past based on a unique source identifier stored in the relay candidate list and indicating the address of a transmission source node, at the following data reception. For example, the average quality of communication can be calculated as a moving average of “the average quality of communication=the average quality of communication in the past×α+the instantaneous quality of communication×(1−α)”. In the above expression, “0<α<1” applies. Averaging the quality of communication can reduce influence of instantaneous degradation of the quality of wireless communication.

If an algorithm for selecting a parent node prioritizes selection of a node with a higher quality of wireless communication, the quality of communication can be set as follows. For example, the communication device 100 adds a destination selection frequency indicating the number of times that the own node is selected as a destination by a child node, and a reception frequency indicating the number of times that the own node has received data from the child node, to the relay candidate list. Then, the communication device 100 applies a result obtained by dividing the destination selection frequency by the reception frequency, as the quality of communication. This quality of communication is equivalent to the averaged quality of communication described above. In other words, if the algorithm prioritizes selection of a node with a higher quality of wireless communication, the ratio of the destination selection frequency relative to the reception frequency is high, and thus “(the destination selection frequency)/(the reception frequency)” can be applied as an equivalent to the averaged quality of communication. The destination selection frequency and the reception frequency are counted at a plurality of data receptions, and thus the relay candidate list is updated (incremented) instead of being deleted.

The identifier 106 identifies the first data and the third data as relay data. More specifically, the identifier 106 identifies, as relay data, the first data classified by the classifier 103 and the third data extracted by the extractor 104. The relay data may include data measured by the sensor device 17 in addition to the first data and the third data. The sensor controller 107 controls measurement by the sensor device 17 and outputs measured data at the identification of relay data by the identifier 106. Accordingly, the identifier 106 identifies, in addition to the first data and the third data, the measured data input by the sensor controller 107 as relay data.

The transmission controller 108 controls transmission processing of transmission data as a radio signal by the communication I/F 15. The transmission data corresponds to relay data identified by the identifier 106. The sleep controller 109 controls sleep and wake-up of the above-described units. The timing of the processing by the sleep controller 109 will be described later. The present embodiment is a technique for achieving reliable communication in a wireless mesh network and a wireless mesh protocol that are capable of performing power saving operation with restricted communication opportunities. The present embodiment is, however, not limited thereto, and is applicable to other wireless mesh network and wireless mesh protocol.

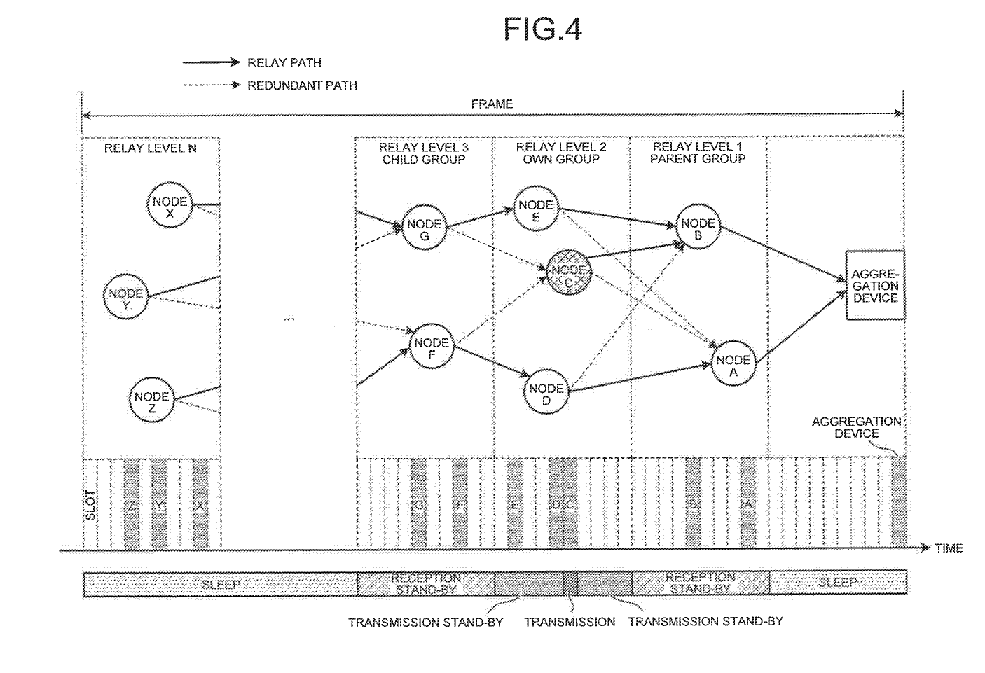

FIG. 4 is a diagram illustrating an exemplary wireless communication method executed by the communication device 100 according to the first embodiment. As illustrated in FIG. 4, in the present embodiment, a parent node is defined to be a node set as a destination by the own node and a higher node closer to the aggregation device 200. Similarly, a child node is defined as a node that sets the own node as a destination and a lower node farther from the aggregation device 200. A plurality of parent nodes are grouped to define a parent group as a group of parent nodes, and a plurality of child nodes are grouped to define a child group as a group of child nodes. Similarly, an own group is defined as a group including the own node. FIG. 4 exemplarily illustrates the relay determination system 1 including the parent group as relay level 1, the own group as relay level 2, the child group an relay level 3, and other relay levels up to relay level N.

The wireless communication method according to the present embodiment employs time-divisional communication in which time is divided into units called slots, and upstream communication from each node to the aggregation device 200 is performed in a frame as a bundle of slots. One slot in one frame is allocated to each node as a transmission opportunity. The nodes are divided into groups in accordance with the level of relay to the aggregation device 200, and slots are allocated to the groups in a descending order of the relay level. In the example illustrated in FIG. 4, 10 slots are allocated to each group, and the allocation starts at relay level N.

To relay data from a child node, each node (own node) of the own group becomes a reception stand-by state during 10 slots allocated to the child group. To perform time synchronization with a parent node or to check whether data transmitted by each node (own node) is relayed, each node (own node) of the own group becomes the reception stand-by state during 10 slots allocated to the parent group. Each node (own node) of the own group performs, within the own group, transmission stand-by and transmission execution during transmission slots allocated to the own group. Each node (own node) of the own group sleeps during slots other than slots for the child group, the own group, and the parent group, thereby achieving power saving. In other words, each communication device 100 sleeps during slots other than reception stand-by slots for the child group, transmission stand-by and transmission execution slots for the own group, and reception stand-by slots for the parent group, but wakes up during reception stand-by slots for the child group. In FIG. 4, a relay path (solid line arrow) indicates a path a destination of which is set in advance, and a redundant path (dashed line arrow) indicates a path for path redundancy.

When the power is turned on, the communication device 100 according to the present embodiment shifts to a network participation state for participating in a wireless mesh network. In this state, collection of any parameter used for participating in the network and identification of a parent node are performed. Specifically, the communication device 100 becomes the reception stand-by state, and receives a radio signal transmitted from any neighboring node to collect information such as a relay level, a destination, and a transmission slot. Simultaneously, the communication device 100 performs measurement of the quality of communication described above. A relay level and a reception intensity are used to select a parent node. For example, a node with a small relay level and a high quality of communication may be selected as a parent node. When the selection of a parent node is completed, the communication device 100 shifts to a sleep state or a communication state in which communication is possible. In the sleep state, when tasks to be processed, such as a communication slot and acquisition of measured data from the sensor device 17, do not exist, the communication device 100 puts, for example, processors such as a CPU and a microcomputer, and the communication I/F 15 into sleep states so as to achieve reduced electric power consumption.

The communication state includes the above-described three states of the reception stand-by state for the child group, the transmission stand-by and transmission execution state for the own group, and the reception stand-by state for the parent group. During these three states, reception of data from a child node, transmission of data to a parent node, and reception of data from a parent node are performed. When there is no task to be processed during the communication state, the communication device may shift to the sleep state to achieve power saving. When data from a parent node cannot be received a certain number of times due to, for example, time synchronization mismatch and noise during the communication state, the communication device 100 shifts back to the network participation state to perform a search for a neighboring node again.

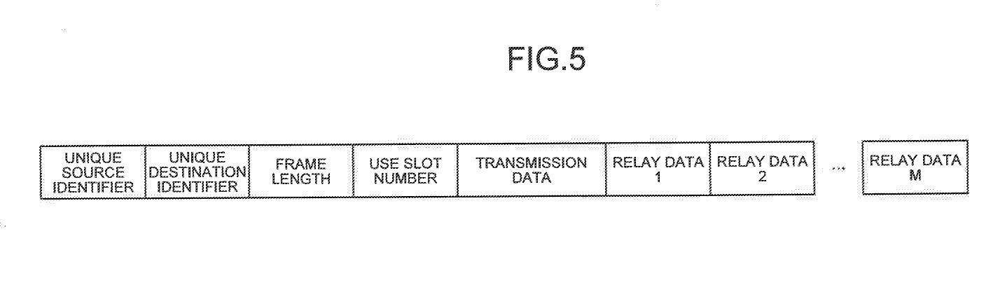

FIG. 5 is a diagram illustrating an exemplary communication frame used in the relay determination system 1 according to the first embodiment. As illustrated in FIG. 5, the communication frame includes a unique source identifier, a unique destination identifier, a frame length, a use slot number, transmission data, and zero or one or more pieces of relay data. When transmitting data, the communication device 100 stores the own address in the unique source identifier, and stores the address of a destination in the unique destination identifier. As described above, when receiving data, the communication device 100 compares the own address and the unique destination identifier included in received data. The communication device 100 determines that the received data is addressed to the own node if a match is made in the comparison, and determines that the received data is not addressed to the own node if no match is made in the comparison.

The frame length is information indicating the length of the frame illustrated in FIG. 4. The use slot number is information indicating a slot number allocated at transmission of data by a transmission source node. The entire frame and the total number of slots can be calculated from the use slot number, the frame length, and a predetermined slot length. In a case of a system with a predetermined frame length, the frame length may be excluded from the communication frame. The communication frame may include a slot length.

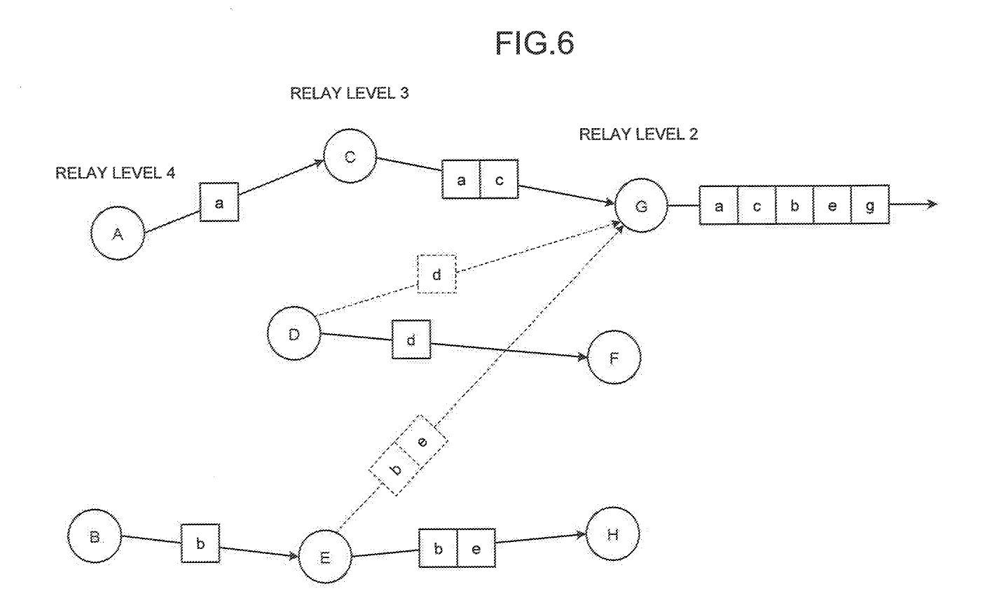

FIG. 6 is a diagram illustrating exemplary processing using the determination criterion according to the first embodiment. The determination criterion according to the first embodiment is such that relay candidate data received from a node having a lower quality of communication with the own node is set as one piece of the relay data. FIG. 6 exemplarily illustrates node A, node B, node C, node D, node E, node F, node G, and node H as the communication devices 100. Node A and node B are included in relay level 4, node C, node D and node E are included in relay level 3, node G, node F, and node H are included in relay level 2. In FIG. 6, for the purpose of illustration, some redundant paths (dashed line arrows) are omitted. A solid line arrow represents a relay path.

As illustrated in FIG. 6, node A in relay level 4 transmits data a to node C in relay level 3 through a relay path. Node C in relay level 3 transmits data a received from node A and data c transmitted by the own node to node G in relay level 2 through a relay path. Node D in relay level 3 transmits data d to node F in relay level 2 through a relay path. Node D in relay level 3 transmits data d to node G in relay level 2 through a redundant path. Node B in relay level 4 transmits data b to node E in relay level 3 through a relay path. Node E in relay level 3 transmits data b received from node B and data e transmitted by the own node to node H in relay level 2 through a relay path. Node E in relay level 3 transmits data b received from node B and data e transmitted by the own node to node G in relay level 2 through a redundant path.

The following describes relay data transmitted by node G in relay level 2. Node G in relay level 2 receives data from node C, node D, and node E. Thus, the relay candidate list at node G stores therein information on the data received from node C, node D, and node E. In this case, node G sets data a and data c received from node C as the first data that is one piece of the relay data, because the unique destination identifier of the data received from node C indicates the address of the own node, in other words, the data received from node C is addressed to the own node.

Then, node G determines whether data received from node D and node E is to be selected as relay data using the determination criterion related to the quality of communication. As a result of measurement of the quality of communication, when node E is further spatially distant from the own node than node D and thus has a lower quality of communication, node G extracts data b and data e received from node E as the third data that is one piece of the relay data, under a condition of N=1. Consequently, node G transmits data a, data c, data b, data e, and data g transmitted by the own node and including data measured by, for example, the sensor device 17, as relay data to a higher node. In other words, the communication device 100 transmits, as relay data, data received from a child node that is further spatially distant, and thus can have more spatially dispersive redundant paths.

Before the processing using the determination criterion according to the first embodiment, the communication device 100 may perform a comparison with a predetermined threshold related to the quality of communication and delete, from the relay candidate list, data received from a child node having a higher quality of communication than the predetermined threshold. For example, assume that all child nodes as relay candidates are spatially close to the own node. When all child nodes as relay candidates are spatially close to the own node, redundant paths are spatially close to each other, which potentially degrades the effect of path redundancy. Thus, the degradation of the effect of path redundancy can be reduced by the comparison with the predetermined threshold related to the quality of communication.

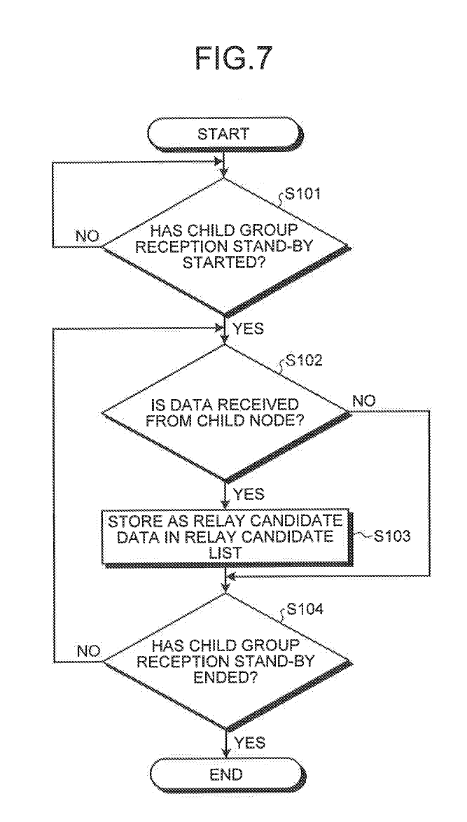

FIG. 7 is a flowchart of an exemplary process of processing at the reception stand-by for the child group according to the first embodiment. As illustrated in FIG. 7, if the reception stand-by for the child group has started (Yes at step S101), the communication device 100 determines whether data is received from a child node (step S102). If the reception stand-by for the child group has not started (No at step S101), the communication device 100 stands-by for the start of the reception stand-by. In this case, the communication device 100 potentially shifts to the sleep state if there is no task to be processed.

If data is received from a child node (Yes at step S102), the communication device 100 stores the received data as relay candidate data in the relay candidate list (step S103). Information including the unique source identifier, the unique destination identifier, transmission data of the child node, and relay data that are included in the received data is added to the relay candidate list. If data is not received from a child node (No at step S102), the communication device 100 executes processing at step S104. The communication device 100 determines whether the reception stand-by state for the child group has ended (step S104). If the reception stand-by state for the child group has not ended (No at step S104), the communication device 100 executes processing at step S102. If the reception stand-by state for the child group has ended (Yes at step S104), the communication device 100 ends the process. In other words, if data has been received from a child node during the reception stand-by state for the child group, the communication device 100 continuously performs processing of adding the received data as relay candidate data to the relay candidate list.

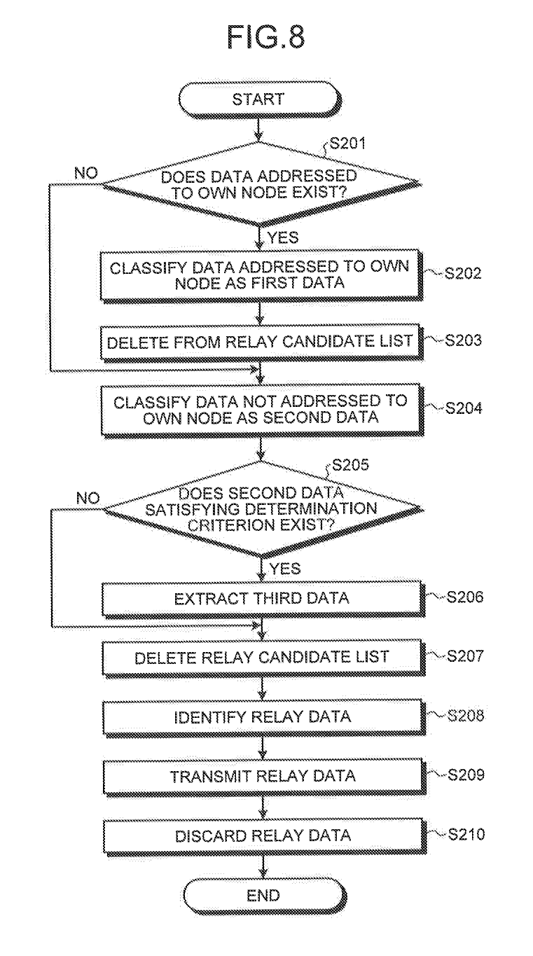

FIG. 8 is a flowchart of an exemplary process of processing at transmission for the own group according to the first embodiment. As illustrated in FIG. 8, the communication device 100 checks the relay candidate list generated during the reception stand-by state for the child group to determine whether data addressed to the own node exists based on the unique destination identifier (step S201). If data addressed to the own node exists (Yes at step S201), the communication device 100 classifies the data addressed to the own node as the first data that is one piece of the relay data (step S202). If no data addressed to the own node exists (No at step S201), the communication device 100 executes processing at step S204. Then, the communication device 100 deletes this relay candidate data classified as the first data from the relay candidate list (step S203).

Subsequently, the communication device 100 classifies data not addressed to the own node as the second data (step S204), and determines whether the second data satisfying the determination criterion exists (step S205). In the processing of determining whether the second data satisfying the determination criterion exists, the instantaneous quality of communication between the own node and a child node is measured. As described above, the determination criterion is such that data received from a child node having a lower quality of communication with the own node is set as relay data. If the second data satisfying the determination criterion exists (Yes at step S205), the communication device 100 extracts the third data applied as one piece of the relay data (step S206). If no second data satisfying the determination criterion exists (No at step S205), the communication device 100 executes processing at step S207.

Thereafter, the communication device 100 deletes the relay candidate list (step S207), and identifies, as the relay data, the first data, the third data, data measured by the sensor device 17, and other data (step S208). Then, the communication device 100 transmits the relay data to a parent node in a transmission slot allocated to the own node (step S209). Then, the communication device 100 discards the relay data the transmission of which is completed (step S210). Thereafter, the transmission state for the own group ends.

As described above, the quality of communication may additionally include a parameter of the quality of communication in the past. If a parameter of the quality of communication in the past is additionally included, the deletion of the relay candidate list is not performed. The process of processing using the parameter of the quality of communication in the past will be described below. The processing during the reception stand-by state for the child group is different from the process of processing illustrated in FIG. 7 in the processing at step S103. Specifically, in the processing, the relay candidate list is updated if the relay candidate list corresponding to received data exists because the parameter of the quality of communication in the past is additionally included, or the received data is stored as relay candidate data in the relay candidate list similarly to FIG. 7 if no relay candidate list corresponding to received data exists. The average quality of communication may be calculated at this point or at transmission of relay data described below.

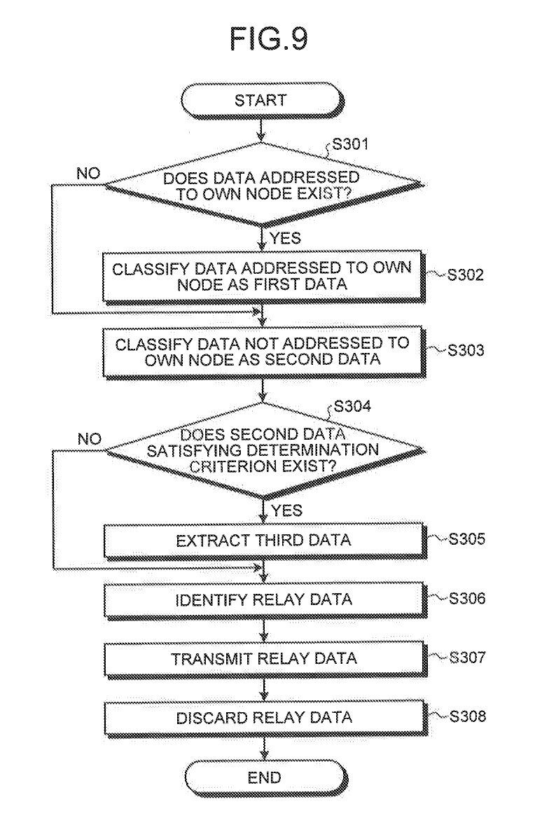

FIG. 9 is a flowchart of an exemplary process of processing at the transmission for the own group according to the first embodiment. As illustrated in FIG. 9, the communication device 100 checks the relay candidate list updated during the reception stand-by state for the child group to determine whether data addressed to the own node exists based on the unique destination identifier (step S301). If data addressed to the own node exists (Yes at step S301), the communication device 100 classifies the data addressed to the own node as the first data that is one piece of the relay data (step S302). If no data addressed to the own node exists (No at step S301), the communication device 100 executes processing at step S303. The deletion of the relay candidate list is not performed because information on the quality of communication is used in the following iteration of processing.

Then, the communication device 100 classifies data not addressed to the own node as the second data (step S303), and determines whether the second data satisfying the determination criterion exists (step S304). In the processing of determining whether the second data satisfying the determination criterion exists, the average quality of communication in the past and the instantaneous quality of communication between the own node and a child node are used. The determination criterion is such that data received from a child node having a lower quality of communication with the own node is set as relay data. If the second data satisfying the determination criterion exists (Yes at step S304), the communication device 100 extracts the third data applied as one piece of relay data (step S305). If no second data satisfying the determination criterion exists (No at step S304), the communication device 100 executes processing at step S306. The deletion of the relay candidate list is not performed because information on the quality of communication is used in the following iteration of processing.

Subsequently, the communication device 100 identifies, as relay data, the first data, the third data, data measured by the sensor device 17, and other data (step S306). Then, the communication device 100 transmits the relay data to a parent node in a transmission slot allocated to the own node (step S307). Then, the communication device 100 discards relay data the transmission of which is completed (step S308). Thereafter, the transmission state for the own group ends. If the quality of communication using the destination selection frequency and the reception frequency is applied, the relay candidate list is not deleted, and thus the flowchart illustrated in FIG. 9 can be applied.

According to the embodiment, the communication device 100 extracts relay data from among data received from a plurality of child nodes included in the child group, in accordance with the determination criterion, and transmits the relay data, thereby suppressing increase in a network load and lack of wireless bandwidth to achieve highly reliable communication. The communication device 100 selects the relay data to achieve path redundancy upon reception of data from a child node, and thus the child node does not need to perform any addition to transmission data, and the path redundancy can be autonomously achieved.

The communication device 100 uses, as parameters of the quality of communication, for example, the instantaneous quality of communication, the average quality of communication in the past, and the ratio of the destination selection frequency relative to the reception frequency used when the algorithm for selecting a parent node prioritizes selection of node having a higher quality of wireless communication, thereby achieving selection of relay data on which a preferable quality of communication is applied in accordance with various kinds of conditions.

### Second Embodiment

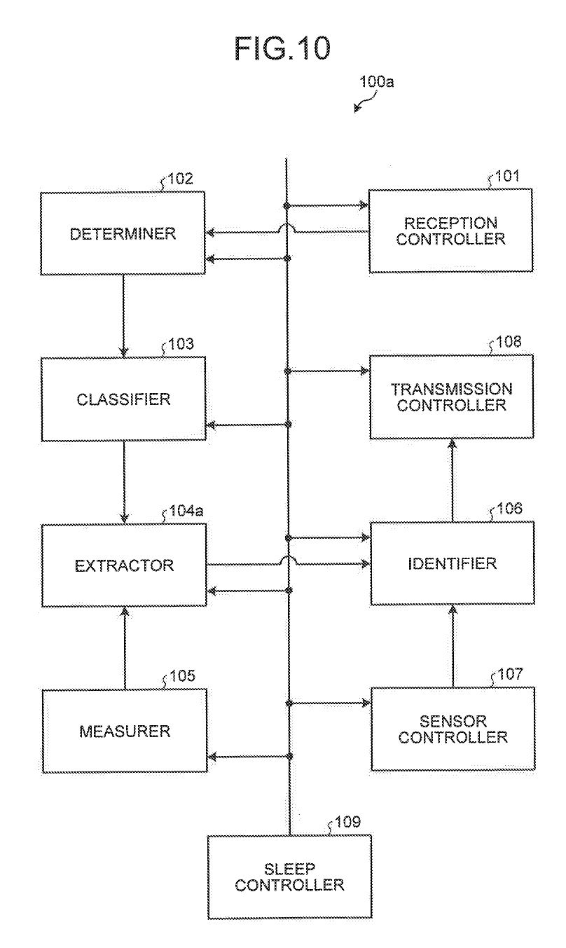

FIG. 10 is a block diagram of an exemplary functional configuration of a communication device 100a according to a second embodiment. In the second embodiment, the same configuration as the functional configuration of the communication device 100 according to the first embodiment is denoted by an identical reference sign, and detailed description thereof is omitted in some cases. Specifically, other units than an extractor 104a described below have the same functions as the functions of the units according to the first embodiment.

As illustrated in FIG. 10, the communication device 100a includes the reception controller 101, the determiner 102, the classifier 103, the extractor 104a, the measurer 105, the identifier 106, the sensor controller 107, the transmission controller 108, and the sleep controller 109. Part or all of these units may be achieved by software (computer program) or by hardware.

The extractor 104a extracts the third data satisfying the determination criterion for setting, as relay data, the second data having a lower similarity to the first data. More specifically, the extractor 104a extracts, as the third data, the second data having a lower similarity to the first data already set as one piece of the relay data, from among relay candidate data included in the relay candidate list. The similarity is information indicating the amount of identical data included. For example, the similarity between data X containing “a, b, c” and data Y containing “a, c, d” is “2” because “a, c” are identical. Similarly, the similarity between data X containing “a, b, c” and data Z containing “b, e, f” is “i” because “b” is identical. In this example, data Z has a lower similarity to data X.

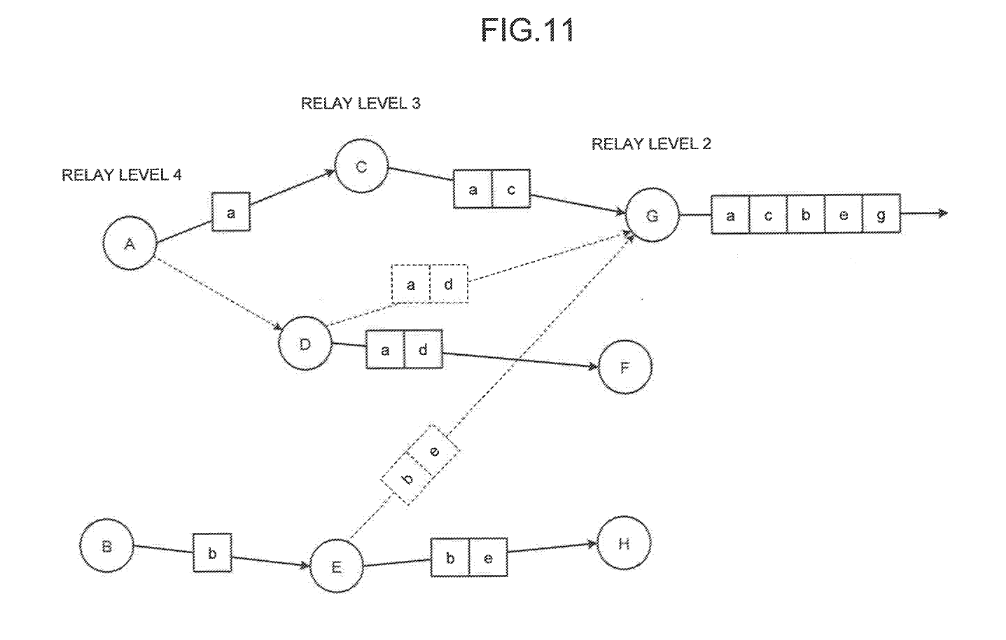

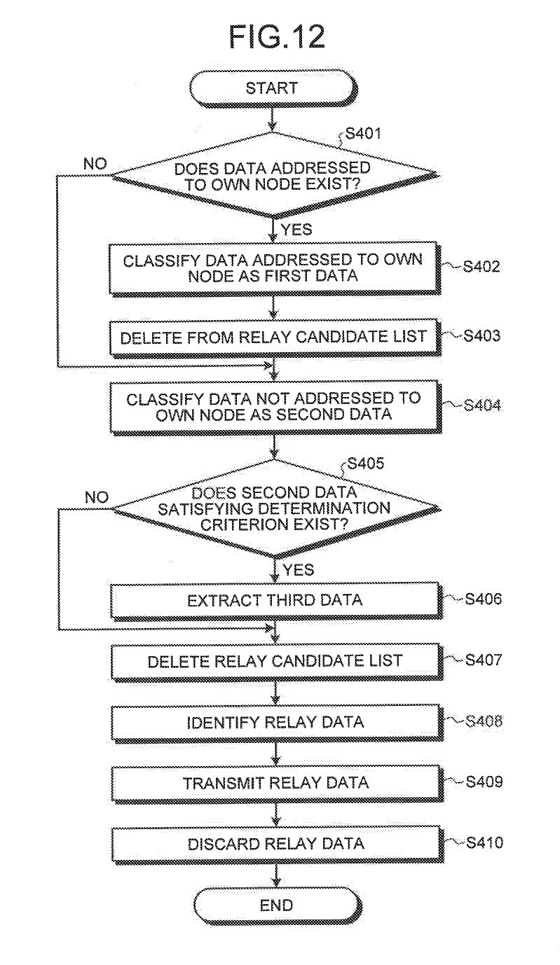

FIG. 11 is a diagram illustrating exemplary processing using the determination criterion according to the second embodiment. The determination criterion according to the second embodiment is such that relay candidate data having a lower similarity to the first data already set as the relay data is set as one piece of the relay data. FIG. 11 exemplarily illustrates node A, node B, node C, node D, node E, node F, node G, and node H as the communication devices 100a. Node A and node B are included in relay level 4, node C, node D, and node E are included in relay level 3, node G, node F, and node H are included in relay level 2. In FIG. 12, for the purpose of illustration, some redundant paths (dashed line arrow) are omitted. A solid line arrow represents a relay path.

As illustrated in FIG. 11, node A in relay level 4 transmits data a to node C in relay level 3 through a relay path. Node A in relay level 4 transmits data a to node D in relay level 3 through a redundant path. Node C in relay level 3 transmits data a received from node A and data c transmitted by the own node to node G in relay level 2 through a relay path. Node D in relay level 3 transmits data a received from node A and data d transmitted by the own node to node F in relay level 2 through a relay path. Node D in relay level 3 transmits data a received from node A and data d transmitted by the own node to node G in relay level 2 through a redundant path. Node B in relay level 4 transmits data b to node E in relay level 3 through a relay path. Node E in relay level 3 transmits data b received from node B and data e transmitted by the own node to node H in relay level 2 through a relay path. Node E in relay level 3 transmits data b received from node B and data e transmitted by the own node to node G in relay level 2 through a redundant path.

The following describes relay data transmitted by node G in relay level 2. Node G in relay level 2 receives data from node C, node D, and node E. Thus, the relay candidate list at node G stores therein information on the data received from node C, node D, and node E. In this case, node G sets data a and data c received from node C as the first data that is one piece of the relay data, because the unique destination identifier of the data received from node C indicates the address of the own node, in other words, the data received from node C is addressed to the own node.

Then, node G determines whether the data received from node D and node E is to be selected as relay data using the determination criterion related to the similarity to the first data. In the example illustrated in FIG. 11, the similarity between the first data “a, c” received from node C, and the second data “a, d” received from node D, and the similarity between the first data “a, c” received from node C and the second data “b, e” received from node E are calculated. The similarity between the first data “a, c” received from node C and the second data “a, d” received from node D is calculated to be “1”. The similarity between the first data “a, c” received from node C and the second data “b, e” received from node E is calculated to be “0”.

As a result of the similarity calculation, if data received from node E has a lower similarity to data received from node C (already set as relay data) than data received from node D, then node G extracts data b and data e received from node E as the third data that is one piece of the relay data, under a condition of N=1. Consequently, node G transmits data a, data c, data b, data e, and data g transmitted by the own node and including data measured by, for example, the sensor devices 17, as relay data to a higher node. In other words, the communication device 100a sets, as relay data, data more different from data relayed by the own device, thereby achieving higher path redundancy.

FIG. 12 is a flowchart of an exemplary process of processing at the transmission for the own group according to the second embodiment. As illustrated in FIG. 12, the communication device 100a checks the relay candidate list generated during the reception stand-by state for the child group to determine whether data addressed to the own node exists based on the unique destination identifier (step S401). If data addressed to the own node exists (Yes at step S401), the communication device 100a classifies the data addressed to the own node as the first data that is one piece of the relay data (step S402). If no data addressed to the own node exists (No at step S401), the communication device 100a executes processing at step S404. Then, the communication device 100a deletes relay candidate data classified as the first data from the relay candidate list (step S403).

Subsequently, the communication device 100a classifies data not addressed to the own node as the second data (step S404), and determines whether the second data satisfying the determination criterion exists (step S405). In the processing of determining whether the second data satisfying the determination criterion exists, the similarity between the first data already classified as one piece of the relay data and the second data not addressed to the own node is calculated. As described above, the determination criterion is such that the second data having a lower similarity to the first data is set as the relay data. If the second data satisfying the determination criterion exists (Yes at step S405), the communication device 100a extracts the third data applied as one piece of the relay data (step S406). If no second data satisfying the determination criterion exists (No at step S405), the communication device 100a executes processing at step S407. If no first data exists for the calculation of the similarity between the first data and the second data, the processing using the quality of communication described in the first embodiment may be performed.

Thereafter, the communication device 100a deletes the relay candidate list (step S407), and identifies the first data, the third data, data measured by the sensor devices 17, and other data, as the relay data (step S408). Then, the communication device 100a transmits the relay data to a parent node in a transmission slot allocated to the own node, (step S409). Then, the communication device 100a discards the relay data the transmission of which is completed (step S410). Thereafter, the transmission state for the own group ends.

According to the embodiment, the communication device 100a calculates the similarity of data received from a plurality of child nodes included in the child group to transmission data by the own node, and then extracts and transmits relay data in accordance with the determination criterion for applying the received data having a lower similarity as relay data, thereby suppressing increase in a network load and lack of wireless bandwidth to achieve highly reliable communication.

### Third Embodiment

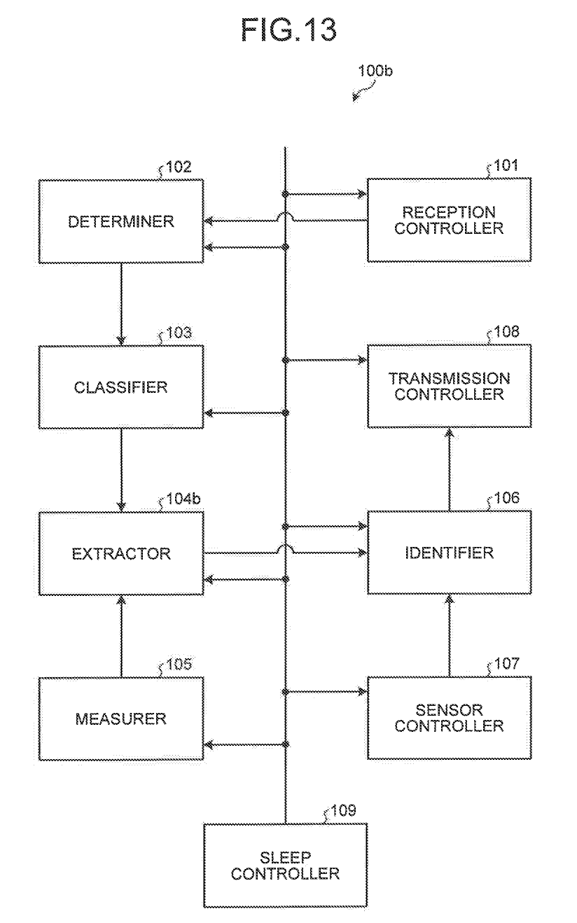

FIG. 13 is a block diagram of an exemplary functional configuration of a communication device 100b according to a third embodiment. In the third embodiment, the same configuration as the functional configuration of the communication device 100 according to the first embodiment is denoted by an identical reference sign, and detailed description thereof is omitted in some cases. Specifically, other units than an extractor 104b described below have the same functions as the functions of the units according to the first embodiment.

As illustrated in FIG. 13, the communication device 100b includes the reception controller 101, the determiner 102, the classifier 103, the extractor 104b, the measurer 105, the identifier 106, the sensor controller 107, the transmission controller 108, and the sleep controller 109. Part or all of these units may be achieved by software (computer program) or by hardware.

The extractor 104b extracts, using relay information indicating whether relay data transmitted by a parent node last time includes relay data of the own node, the third data satisfying the determination criterion for setting, as relay data, the second data having relay information indicating that the relay data of the own node is not included. In the third embodiment, a relay flag is added to transmission data of each communication device 100b. The relay flag indicates whether relay data transmitted by a parent node last time includes the relay data of the own node. With this flag, if the relay data of the own node is not included in the relay data transmitted by a parent node last time, the relay data of the own node will be relayed by the parent node at the next data transmission, thereby achieving path redundancy.

The relay flag is updated during the reception stand-by state for the parent group. For example, the communication device 100b initializes the relay flag to False when the reception stand-by state for the parent group is started. The False relay flag indicates that the relay data of the own node is not included in the relay data transmitted by a parent node last time. Then, when data is received from the parent node, the communication device 100b checks whether the relay data of the own node is included in the relay data transmitted by the parent node last time, and updates the relay flag to True if the relay data of the own node is included. The communication device 100b can notify the parent node that the transmission data of the own node is not relayed at the last data transmission, by adding the relay flag to data to be transmitted next.

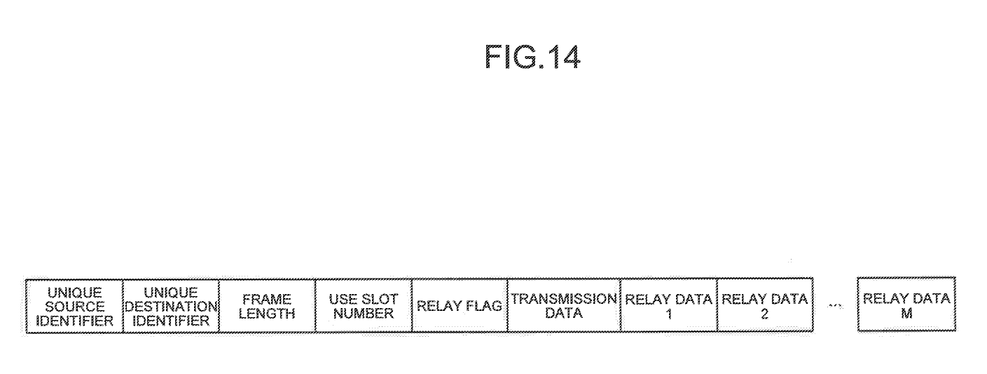

FIG. 14 is a diagram illustrating an exemplary communication frame used in the relay determination system 1 according to the third embodiment. In the third embodiment, the following information including the relay flag is stored in the relay candidate list during the reception stand-by state for the child group. As illustrated in FIG. 14, the communication frame includes the unique source identifier, the unique destination identifier, the frame length, the use slot number, the relay flag, transmission data, and zero or one or more pieces of relay data.

The determination criterion used by the extractor 104b is such that, in the relay candidate list including the relay flag, data with the False relay flag is set as relay data. Accordingly, having received data with the False relay flag, a parent node selects the data as relay data and provides path redundancy, whereby data from a node with a high possibility for unsuccessful reception can be relayed through a redundant path.

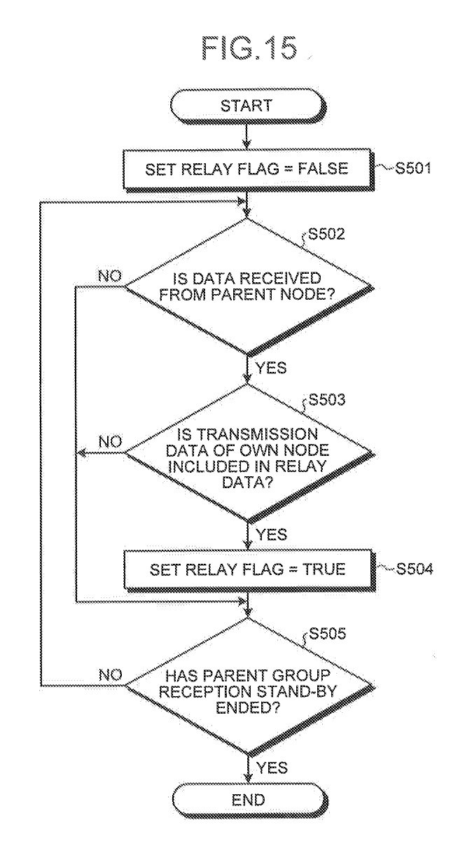

FIG. 15 is a flowchart of an exemplary process of update processing of the relay flag according to the third embodiment. As illustrated in FIG. 15, if the reception stand-by state for the parent group is started, the communication device 100b initializes the relay flag to False (step S501). Then, the communication device 100b determines whether data is received from a parent node (step S502). If data is received from a parent node (Yes at step S502), the communication device 100b determines whether the transmission data of the own node is included in relay data transmitted by the parent node last time (step S503). If data is not receive from a parent node (No at step S502), the communication device 100b executes processing at step S505.

Then, if the transmission data of the own node is included in the relay data transmitted by a parent node last time (Yes at step S503), the communication device 100b updates the relay flag included in the relay candidate list to True (step S504). If the transmission data of the own node is not included in the relay data transmitted by a parent node last time (No at step S503), the communication device 100b executes processing at step S505.

If the reception stand-by state for the parent group has ended (Yes at step S505), the communication device 100b ends the process. If the reception stand-by state for the parent group has not ended (No at step S505), the communication device 100b executes processing at step S502. In other words, the communication device 100b initializes the relay flag to False during the reception stand-by state for the parent group. Then, upon reception of data from a parent node, if the transmission data of the own node is not included in the relay data transmitted by a parent node last time, the communication device 100b leaves the relay flag as False without update.

The relay flag may be updated at a timing different from the reception stand-by state for the parent group. Specifically, in addition to slots for the parent group and the child group, the communication device 100b is provided with a reception slot for notifying an unsuccessful relay by the parent node, if it is determined that a parent node could not relay data of the own node in the last frame. This reception slot is referred to as an unsuccessful relay notification reception slot. The communication device 100b performs relay transmission of data of a child node received in the unsuccessful relay notification reception slot, in a transmission slot in the same frame. Accordingly, whether there is a reception in the unsuccessful relay notification reception slot is set as the False or True relay flag.

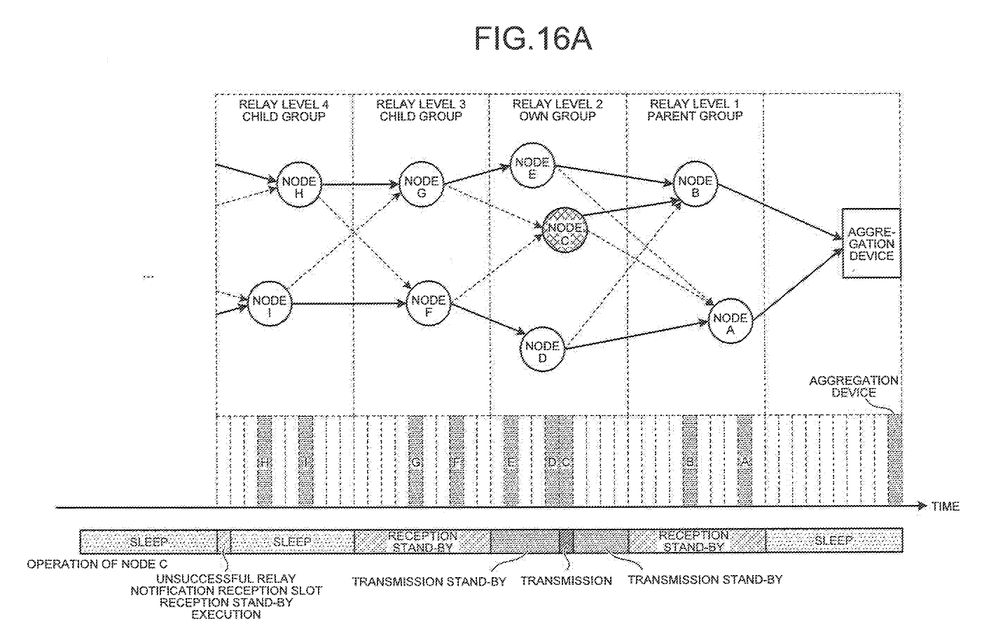

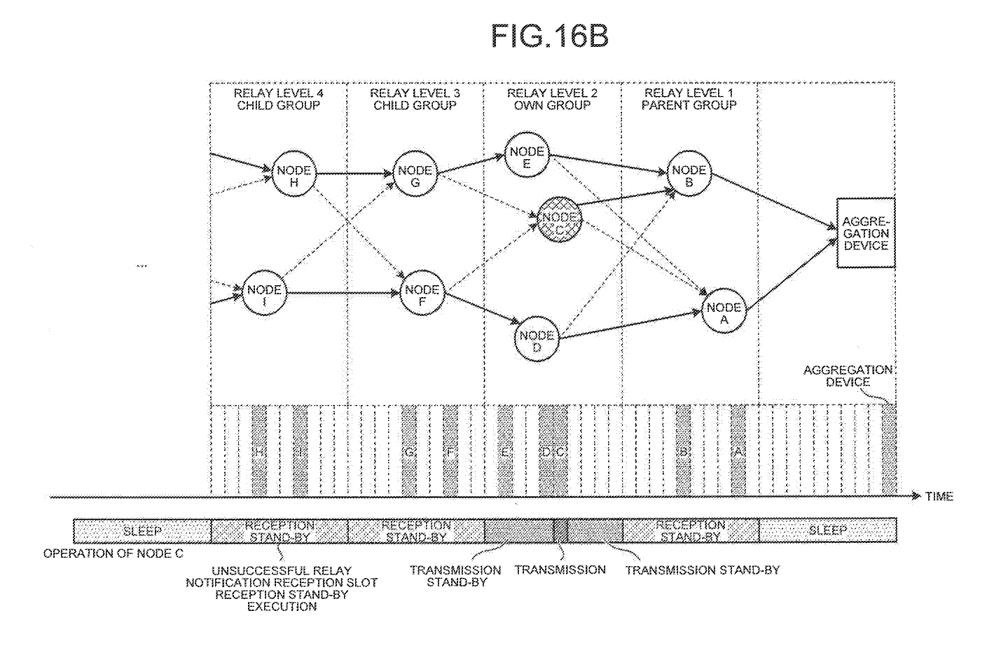

FIGS. 16A and 16B are each a diagram illustrating an exemplary wireless communication method executed by the communication device 100b according to the third embodiment. As illustrated in FIGS. 16A and 16B, when relay level 2 is set to the own group, the unsuccessful relay notification reception slot is allocated at a time earlier than a reception slot allocated to the child group in relay level 3. In other words, the unsuccessful relay notification reception slot is allocated for transmitting data that could not be relayed in the frame. In FIG. 16A, one reception slot is allocated to each node of the own group in relay level 2. In FIG. 16B, a set of reception slots allocated to the group in relay level 4 are allocated to the nodes of the own group in relay level 2.

In the example illustrated in FIG. 16A, any of reception slots allocated to the group in relay level 4 is allocated as the unsuccessful relay notification reception slot. In other words, any of slots allocated to a group in relay level L+2 or larger needs to be allocated to a node in relay level L. In FIG. 16A, node C, node D, and node E in relay level 2 each perform reception stand-by in the unsuccessful relay notification reception slot as the earliest slot of reception slots allocated to the group in relay level 4. Data received in the unsuccessful relay notification reception slot is subjected to relay transmission as relay data with the relay flag set to False, whether the data is addressed to the own node. If data of the own node is not relayed by the parent nodes in the last frame, each of node F and node G as child nodes of node C, node D, and node E wakes up to transmit data in the unsuccessful relay notification reception slot of the parent nodes and the parent group in the next frame. In the example illustrated in FIG. 16A, a child node transmits data by broadcasting, thereby requesting path redundancy to all nodes of the parent group at a distance at which reception is possible. In this case, data not relayed in the last frame may be transmitted again.

In the example illustrated in FIG. 16B, a set of reception slots allocated to the group in relay level 4 are allocated as the unsuccessful relay notification reception slots. In FIG. 16B, node C, node D, and node E in relay level 2 each perform reception stand-by in the unsuccessful relay notification reception slots as the set of reception slots allocated to the group in relay level 4. Node F and node G as child nodes of node C, node D, and node E can use any slot in the group in relay level 4 when relay is unsuccessful.

As illustrated in FIG. 16A, when one slot is allocated, since a plurality of child nodes use one unsuccessful relay notification reception slot, a reception stand-by time can be reduced for parent nodes, thereby achieving reduced electric power consumption. As illustrated in FIG. 16B, when a set of slots are allocated, a plurality of child nodes, for which relay is unsuccessful, can use other slots to transmit data to nodes of the parent group without collisions. The allocation of the unsuccessful relay notification reception slot can be changed by an implemented application or system. To reduce generation of interference with normal data communication due to the use of the unsuccessful relay notification reception slot, for example, frequencies and channels different from those of the normal data communication are preferably used.

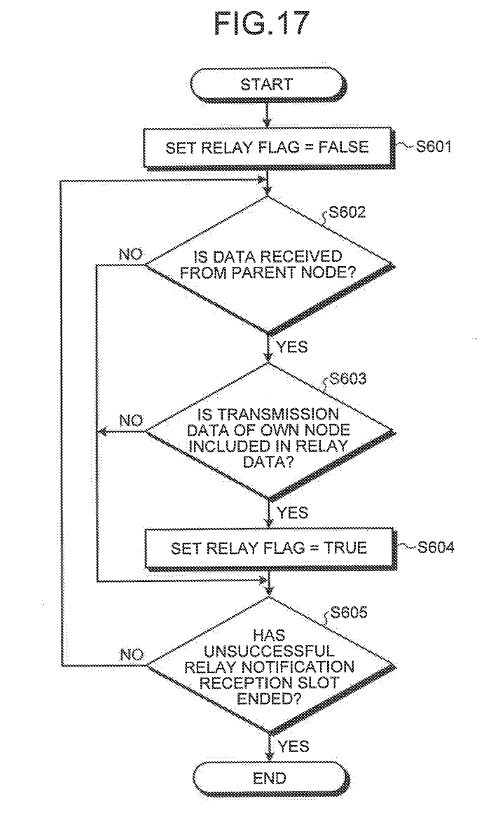

FIG. 17 is a flowchart of an exemplary process of update processing of the relay flag according to the third embodiment. As illustrated in FIG. 17, if the unsuccessful relay notification reception slot is started, the communication device 100b initializes the relay flag to False (step S601). Then, if data is received from a parent node (Yes at step S602), the communication device 100b determines whether the transmission data of the own node is included in relay data transmitted by a parent node last time (step S603). If data is not received from a parent node (No at step S602), the communication device 100b executes processing at step S605.

Then, if the transmission data of the own node is included in the relay data transmitted by a parent node last time (Yes at step S603), the communication device 100b updates the relay flag included in the relay candidate list to True (step S604). if the transmission data of the own node is not included in the relay data transmitted by a parent node last time (No at step S603), the communication device 100b executes processing at step S605.

If the unsuccessful relay notification reception slot has ended (Yes at step S605), the communication device 100b ends the process. If the unsuccessful relay notification reception slot has not ended (No at step S605), the communication device 100b executes processing at step S602.

According to the embodiment, the communication device 100b can use the relay flag, which is updated depending on whether the relay data of the own node is included in relay data transmitted by a parent node last time, to cause the corresponding data to be selected as relay data if the relay flag indicates that the relay data of the own node is not included. Thus, data from a node with a higher unsuccessful data reception possibility can be relayed through redundant paths.

Processing procedures, control procedures, specific names, and information including various kinds of data and parameters in the specification and drawings described above can be optionally changed unless otherwise stated. Components of devices illustrated in the drawings represent conceptual functions and are not necessarily physically configured as illustrated in the drawings. In other words, specific configurations of distribution and integration of the devices are not limited to the illustrated configurations. All or some of the devices may be functionally or physically distributed and integrated in optional units depending on various loads and use conditions.

For example, the determination of relay data can be achieved by processing as a combination of the above-described embodiments. The following describes an exemplary procedure of the determination of relay data.

(1) Data with the False relay flag in the relay candidate list is set as relay data.

(2) If the number of pieces of relay data satisfying of pieces of relay data can be transmitted, the similarity between the first data and other data in the relay candidate list is calculated to set data having a lower similarity as relay data.

(3) If the number of pieces of relay data satisfying (2) is smaller than N, data having a lower quality of communication with the child node corresponding to other data in the relay candidate list is set as relay data.

Consequently, data having a lower similarity is relayed with priority on relaying of data that is not relayed in the last frame, thereby achieving higher path redundancy.

The communication device 100 according to the above-described embodiments can be achieved by using, for example, a general-purpose computer device as basic hardware. An executed computer program has a module configuration including the above-described functions. The executed computer program may be provided in an installable or executable file recorded in a computer-readable recording medium, which may be provided as a computer program product, such as a CD-ROM, a CD-R, or a DVD, or implemented in advance in, for example, a ROM.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A communication device comprising:
a determiner configured to determine whether received data is addressed to the communication device:
an extractor configured to extract data satisfying a determination criterion for setting data as relay data, from received data determined not to be addressed to the communication device; and
an identifier configured to identify, as relay data, received data determined to be addressed to the communication device and the extracted data.

2. The device according to claim 1, further comprising:
a sensor controller configured to control measurement by a sensor;
a reception controller configured to control reception of the received data; and
a transmission controller configured to control transmission of the relay data, wherein
the relay data further includes measured data measured by the sensor.

3. The device according to claim 1, further comprising a measurer configured to measure a quality of communication between the communication device and a transmission source device that is a transmission source of data, wherein
the extractor extracts data satisfying a determination criterion for setting, as relay data, received data received from a transmission source device having a lower quality of communication with the communication device.

4. The device according to claim 3, wherein the measurer sets, as the quality of communication, at least one of a radio wave reception intensity, an index indicating a radio wave reception intensity, a successful reception rate, and a result obtained by dividing a destination selection frequency indicating the number of times that the communication device is selected as a destination by a reception frequency indicating the number of times that received data is received.

5. The device according to claim 1, wherein the extractor extracts, from received data determined not to be addressed to the communication device, data satisfying a determination criterion for setting, as relay data, data having a lower similarity to received data determined to be addressed to the communication device.

6. The device according to claim 1, wherein the extractor extracts data satisfying a determination criterion for setting, as relay data, data including relay information indicating that relay data of the communication device is not included, from received data determined not to be addressed to the communication device, using relay information indicating whether the relay data of the communication device is included in relay data transmitted by a transmission destination device that is a data transmission destination last time.

7. The device according to claim 6, wherein the relay information is updated based on information received from the transmission destination device at a stand-by for reception from the transmission destination device and indicating whether relay data of the communication device is included.

8. The device according to claim 6, wherein the relay information is updated to information indicating that relay data of the communication device is not included, in a case that data is received from the transmission destination device in a time that is earlier than a stand-by for reception of data from a transmission source device that is a data transmission source, the time being set for stand-by for unsuccessful relay notification reception for notification of unsuccessful data relay by the transmission destination device.

9. A relay determination method comprising:
determining whether received data is addressed to a communication device:
extracting data satisfying a determination criterion for setting data as relay data from received data determined not to be addressed to the communication device; and
identifying, as relay data, received data determined to be addressed to the communication device and the extracted data.

10. A computer program product comprising a computer-readable medium containing a program, the program causing the computer to execute:
determining whether received data is addressed to the communication device;
extracting data satisfying a determination criterion for setting data as relay data from received data determined not to be addressed to the communication device; and
identifying, as relay data, received data determined to be addressed to the communication device and the extracted data.
